SEQUENCE LISTING (6 sequences)

SEQ ID NO: 1 - DNA, 69 bp, Artificial
  Designed oligonucleotide primer to amplify DNA encoding human VEGFR2
aattaagtcgacatggactacaaggatgacgatgacaagaagcgggccaatggaggggaactgaagaca

SEQ ID NO: 2 - DNA, 42 bp, Artificial
  Designed oligonucleotide primer to amplify DNA encoding human VEGFR2
aattaagcatgcttaaacaggaggagagctcagtgtggtccc

SEQ ID NO: 3 - DNA, 64 bp, Artificial
  Designed oligonucleotide primer to amplify DNA encoding human BRAF
aaagaattcaccatggactacaaggacgacgatgacaagaccccccctgcctcattacctggct

SEQ ID NO: 4 - DNA, 35 bp, Artificial
  Designed oligonucleotide primer to amplify DNA encoding human BRAF
aaaagtcgactcagtggacaggaaacgcaccatat

SEQ ID NO: 5 - DNA, 29 bp, Artificial
  Designed oligonucleotide primer to introduce V600E mutation
ggtctagctacagagaaatctcgatggag

SEQ ID NO: 6 - DNA, 29 bp, Artificial
  Designed oligonucleotide primer to introduce V600E mutation
ctccatcgagatttctctgtagctagacc

(19) United States
(12) Patent Application Publication
(10) Pub. No.: US 2009/0115970 A1
(43) Pub. Date: May 7, 2009

(54) HIGH EFFICIENCY COMPACT OLED MICRODISPLAY PROJECTION ENGINE

(75) Inventors: Israel J. Morejon, Tampa, FL (US); Jinhui Zhai, Oldsmar, FL (US)

Correspondence Address: Jabil Circuit, Inc.;c/o Darby & Darby P.C., P.O. BOx 770, Church Street Station, New York, NY, 10008-0770, US

(73) Assignee: Jabil Circuit, Inc., St. Petersburg, FL (US)

(21) Appl. No.: 12/263,741

(22) Filed: Nov. 3, 2008

Related U.S. Application Data
(60) Provisional application No. 60/984,744, filed on Nov. 2, 2007.

(51) Int. Cl. G03B 21/14; G03B 21/00

(52) U.S. Cl. 353/38; 353/121

(57) ABSTRACT

A compact micro-display engine having improved efficiency for, e.g., projection displays or personal displays. It includes an emissive micro-display without the need for external illumination, a collimation optic plate on top of micro-display and a low F/# projection optics after the collimation optic plate. The collimation optical plate may be a micro-structure lenses array or a collimation prism film, and is used to collimate wide divergent light from the emissive micro-display device into a small cone angle light which will be efficiently collected by the projection optics. A reflective mirror is deposited on the top of substrate and underneath the light emitting layer for recycling the reflected back light from the collimation optic plate. The compact micro-display projection engine controls the divergence angle of the emitted light, and provides the controlled light to the objective plane of a projection optics subsystem.

### CROSS REFERENCE TO RELATE APPLICATIONS

This application claims priority from U.S. Provisional Patent Application No. 60/984,744, filed Nov. 2, 2007, the content of which is hereby incorporated in its entirety.

### BACKGROUND OF THE INVENTION

1. Statement of the Technical Field

The invention concerns high efficiency compact display technology. More particularly, aspects of the invention concern a small display engine having improved optical efficiency.

2. Description of the Related Art

Micro-display panels are small displays used in personal display and forward projection applications. Such displays have been made from technologies such as liquid crystal display (“LCD”), liquid crystal on silicon (“LCOS”), and digital light projection (“DLP”).

A disadvantage of the existing LCD, LCOS, and DLP technology is that they use external illumination to light up the display. The external illumination makes the projection system more costly, complex, bulky, and consumes more power. Some light sources may have a limited lifetime of approximately 1,000 to 1,500 hours. Lamps, if replaceable, may be expensive when considering the cost of both the lamp and the labor to replace it.

Organic Light Emitting Diode (“OLED”) is another type of display technology. An OLED is any LED whose emissive electroluminescent layer is composed of a film of organic compounds. The technology may also be termed or related to Light Emitting Polymer (“LEP”), Polymer LED (“PLED”), Organic Electro Luminescence (“OEL”), or the like. The difference in physics underlying these light emitting technologies is not significant herein for purposes of embodiments of the invention, and will be referred herein generically as OLED. The emissive electroluminescent layer usually contains a polymer substance that allows suitable organic compounds to be deposited. The compounds are deposited in rows and columns onto a flat carrier by a simple “printing” process. The resulting matrix of pixels can emit light of different colors. Such OLED systems can be used in small, portable display screens (e.g., cell phones and PDAs). OLEDs typically emit less light per area than inorganic solid-state based LEDs which are usually designed for use as point-light sources.

A benefit of OLED displays over traditional LCDs is that OLEDs do not require a backlight to function. Thus they draw far less power and, when powered from a battery, can operate longer on the same charge. Because there is no need for a backlight, an OLED display can be much thinner than an LCD panel.

OLED display technology features low power, self-emitting pixels; high electronic-to-optical conversion efficiency; ultrathin architecture; and capability to be fabricated on a large, thin and flexible substrate. Therefore, OLED is an advantageous technology to replace LCD, LCOS and DLP in flat panel displays, projection displays or personal displays.

OLED micro-display technology combines OLED and CMOS technology, permitting micro-displays to be fabricated using OLED on a silicon backplane. Such an OLED micro-display has the advantage of high resolution in a compact diagonal display (e.g., <1.0″), low power consumption, and a simple engine architecture. The architecture combines emissive display technology with high electronic-to-optical conversion efficiency, while eliminating the requirement for backlighting and/or external illumination.

OLED micro-displays have been used to form the display near the eye, such as a head mounted display and a viewfinder, in which optical efficiency is a lesser concern because of the proximity of the eye. However, for other applications in which the eye is farther from the display, optical efficiency becomes a greater concern. Overall efficiency of OLED micro-displays is determined at least by the electronic-to-optical conversion efficiency in producing emitted photons, and by the efficiency of capturing the emitted photons and employing the captured photons in a display.

Efficiency in capturing the photons in turn depends on a divergent light angle and a light collection angle. A divergent light angle is the solid angle formed by the half-power beam width of the emitted light. A light collection angle is the solid angle through which at least half of the available photons can be captured by a light collection device (e.g., a prism). Although OLED technology has high electronic-to-optical conversion efficiency, the overall efficiency of OLED micro-displays is low because the OLED produces light with a light divergent angle that is wider than the light collection angle of the light collection device. The wider light divergent angle allows emitted photons to escape capture by the light collection device, limiting the apparent brightness of the display and thereby limiting the application of OLED micro-displays in certain display applications.

Compactness is desirable for certain display applications. An example of a compact display used in micro-display technology is a prism optic module. This technology is used, for instance, in head mount display (HMD) applications. This technology projects an image into a prism, wherein the prism is used to fold the light path, thereby providing a relatively long optical path in a relatively compact device, and simultaneously correct for geometric distortions and aberrations with its curved input and output surface. However, the light collection angle of the prism is smaller than the divergent light angle from OLED display, which may be approximately 170° or more. Accordingly, HMD using a prism optic module has low optical efficiency.

### SUMMARY OF THE INVENTION

Embodiments of the present invention relate to a high efficiency compact OLED micro-display projection engine for personal display and front projection applications. Embodiments of the present invention also are directed to method and system for the highly efficient generation and projection of a micro-display.

### BRIEF DESCRIPTION OF THE DRAWINGS

Embodiments will be described with reference to the following drawing figures, in which like numerals represent like items throughout the figures, and in which:

FIG. 1 is a schematic view of an embodiment of a compact OLED micro-display projection engine that is useful for understanding the present invention.

FIG. 2 is a schematic view of an embodiment of a compact OLED micro-display projection engine with an integrated collimation optic plate.

FIG. 3 is a schematic view of an embodiment of the compact OLED projection engine.

FIG. 4 is a cross-sectional view of exemplary light ray paths through a micro prism film.

### DETAILED DESCRIPTION OF THE INVENTION

Embodiments of the present invention are related to OLED micro-displays having improved efficiency. Such micro-displays may be used, for instance, in personal display applications.

Traditional micro-display engines are based on transmissive technology such as LCD, LCOS, or reflective technology such as a DLP micro-display panel. Each of these technologies needs external illumination from an optical system in the projection light engine, resulting in a complex, bulky configuration with relatively high power consumption.

OLED, coupled to a projection optic subsystem, is an alternative technology usable for a micro-display. A conventional projection system may be used with an OLED micro-display for optical 3-D shape detection if there is a way to receive a returned signal, or other projection and imaging applications. Typically, the projection optic subsystem is operable within a predetermined range of F-number values (“F/# range”), usually F#/2.0 or greater (corresponding to a light collection angle of less than 28 degrees), wherein the F-number is known to a person of ordinary skill in the art of optics as the ratio of focal length to diameter of a lens. Only a small portion of light emitting from an OLED micro-display is collected by the projection optic subsystem, therefore, this technology suffers from low optical efficiency.

Embodiments of the present invention improve upon micro-displays known in the background art by providing a more efficient coupling from the light source to the projection optic subsystem, and then to the display. Coupling efficiency is improved by providing a collimation optic plate adjacent to an emissive micro-display, the optical plate collimating the light output from the emissive micro-display before the light enters the projection optic subsystem portion subsystem of an optical display apparatus. The collimation optic plate functions to reduce the divergent light angle from the light source, thereby providing a better match to the light collection angle of the projection optic subsystem.

The emissive micro-display may be an OLED micro-display or other type of emissive display, which emits light so that no additional illumination sources are needed in the projection micro-display system. The emissive micro-display may have a highly reflective layer deposited underneath the light emitting layer, in order to direct wayward light toward the collimation optic plate. The collimation optic plate may be integrated into OLED layer structures, e.g., as a layer fabricated on a substrate, in order to provide better control of the light divergent angle, as well as to improve the light extraction efficiency by reducing total internal reflection (TIR) loss. Without integration, TIR loss would occur as light exits from the OLED layer to air, due to the refractive index mismatch between the OLED layer and the air.

Light emitted by the OLED is directed toward the collimation optic plate. The collimation optic plate uses refraction to collimate light that enters it within a predetermined angle. Light entering the collimation optic plate outside the predetermined angle (e.g., at highly oblique angles) is reflected back toward the OLED by means of total internal reflection and reflection/refraction within the collimation optic plate. Any light reflected back from the collimation optic plate re-enters the OLED layers and will be recycled from a reflective layer under the OLED light emitting layer, and passed again through the collimation optic plate. The light that leaves the film is well collimated

The collimation optic plate structure may be a micro-structure lens array, collimation prism film or other kinds of optical plates with micro-structure to control the output light angle. The OLED micro-display engine in the present invention is ultra-compact and simple configuration, highly efficiency, low power consumption and is capable of being embedded into mobile devices and other personal projection displays.

Advantages compared to the known art include: a compact and simple configuration; high efficiency for personal projection display applications; lower power consumption; no extra illumination optical system is needed; low optical power presents no eye safety issue; no laser speckle phenomena; and a scalable resolution and better image quality.

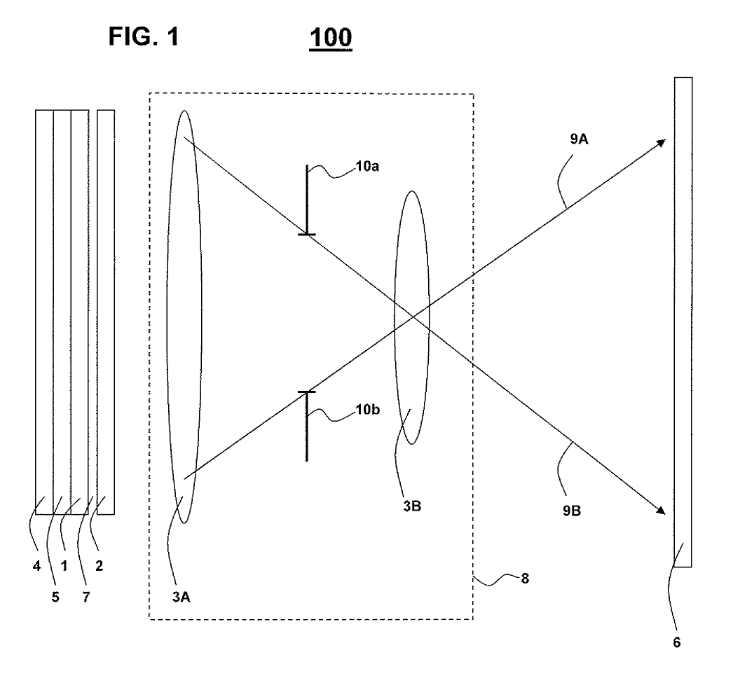

Referring now to FIG. 1, there is provided a schematic view of a high efficiency compact OLED micro-display projection engine 100 that is useful for understanding the present invention. The relative sizes of certain features are exaggerated for clarity. The OLED micro-display projection engine 100 includes a silicon backplane 4 fabricating by, e.g., CMOS technology; a reflective layer 5 deposited on the silicon backplane 4; an OLED light emitting layer 1 disposed on the reflective layer 5; a collimation optic plate 2 adjacent to the OLED light emitting layer 1, and separated from layer 1 by a gap 7, such that light produced by the OLED light emitting layer 1 and/or reflected by the reflective layer 5 is collimated by the collimation optic plate 2; and an exemplary optic subsystem 8 having a low F-number, disposed in a manner to receive the collimated light from the collimation optic plate 2, and produce a projectable image. Markers 10a, 10b illustrate edges of an aperture of the optic subsystem 8, the aperture formed as the gap between markers 10a, 10b. The low F-number is advantageous in permitting the collimation optic plate 2 to be placed near to the OLED light emitting layer 1, thereby permitting a more compact OLED micro-display projection engine 100.

Light rays 9A, 9B illustrate two exemplary light ray paths passing through the projection optic subsystem 8. Light rays 9A, 9B are near opposite outer edges of the image as it passes through the projection optic subsystem 8. The objective plane of projection optic subsystem 8 is near the OLED light emitting layer 1.

In the embodiment shown in FIG. 1, the projection optic subsystem 8 is depicted as an objective lens 3A and a focal lens 3B. The projection optic subsystem 8 is not limited in this regard, and in other embodiments the projection optic subsystem 8 may be used, for instance, an eyepiece or a simple lens magnifier, or a more complex arrangement of a plurality of lenses. The projection optic subsystem 8 produces an image upon a display plane that is viewable either directly (e.g., by an eyepiece) or indirectly (e.g., by a screen).

Optionally, a screen 6 may be disposed in a manner as to be illuminated by the projectable image, producing a viewable image, but a screen 6 is not necessary in order to practice embodiments of the invention described herein. If a screen 6 is not used, then the image may be directly viewable, e.g., by using an eyepiece as the projection optic subsystem 8.

The reflective layer 5 deposited underneath the OLED light emitting layer 1 is useful for improving efficiency by redirecting light toward the collimation optic plate 2.

The collimation optic plate 2 may be a micro-structure lens array, a collimation prism film, or other kind of optical plate having micro-structure configured to control the output light angle from the OLED light emitting layer 1. A portion of the light entering the collimation optic plate 2 will be reflected back toward the OLED light emitting layer 1, depending upon the angle of travel of the light. Light reflected back from the collimation optic plate 2 re-enters the OLED light emitting layer 1 and will be reflected from the reflective layer 5 under the OLED light emitting layer 1, whereupon the light reflected by reflective layer 5 will re-enter the collimation optic plate 2.

The OLED micro-display projection engine 100 does not need external illumination. When OLED light emitting layer 1 is coupled to the collimation optic plate 2, there is produced an optical light engine that is more compact, more efficient, and consumes less power than the light engines of the background art. It should be understood that the OLED light emitting layer 1 is not limited to OLED technology unless explicitly so limited, and another type of emissive technology may be used. It should also be understood that other types of display technology, e.g., non-emissive technologies like LCD, LCOS, and DLP, may replace at least the OLED light emitting layer 1, and thereby produce an embodiment of an optical light engine that is somewhat less compact and/or less efficient, and/or less power conserving compared to an embodiment using the OLED light emitting layer 1, but improved over the background art.

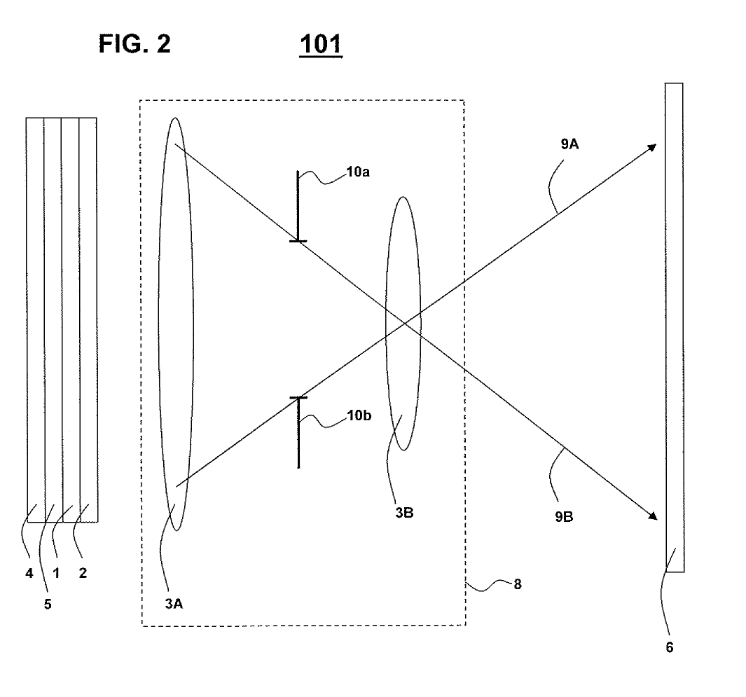

Referring now to FIG. 2, there is provided a schematic view of another embodiment of an OLED micro-display projection engine 101, having collimation optic plate 2 integrated with the OLED light emitting layer 1 as a layer fabricated on OLED light emitting layer 1, removing the gap 7 of engine 100, thereby improving the control over the light divergent angle. Engine 101 is the same as engine 100 in all other aspects. Another benefit of integrating the collimation optic plate 2 with the OLED light emitting layer 1 is that an intervening air interface is eliminated, thereby reducing a total internal reflection (TIR) loss caused by a refractive index mismatch between air and the OLED light emitting layer 1, resulting in improved light extraction efficiency from the OLED light emitting layer 1. Collimated light produced by the collimation optic plate 2 can be more efficiently collected by the low F/# projection optic subsystem 8 and projected onto image screen 6. As with FIG. 1, the projection optic subsystem 8 is not limited to lenses 3A, 3B, and other embodiments are possible. The relative sizes of certain features are exaggerated for clarity.

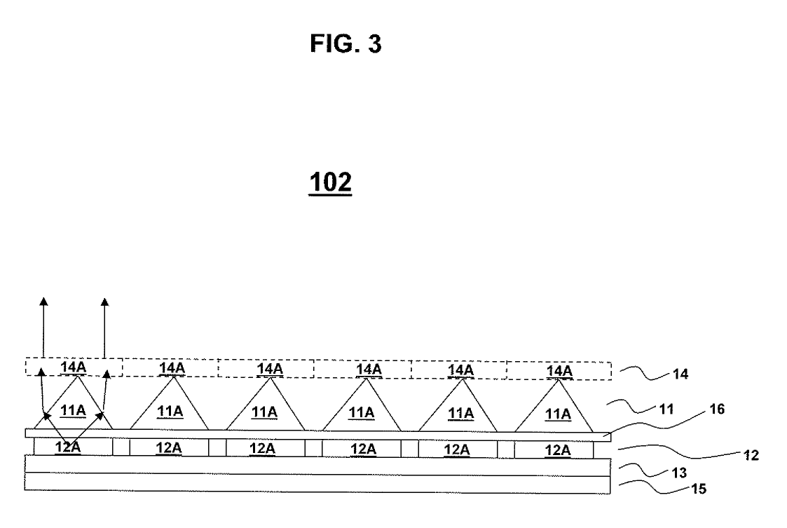

Referring now to FIG. 3, there is provided a schematic view of another embodiment of an OLED micro-display projection engine 102, having an OLED emissive layer 12, an OLED top cover layer 16 overlying the OLED emissive layer 12, and with micro prism film 11 disposed above the OLED top cover layer 16. Layer 16 is an essentially transparent layer that protects the OLED emissive layer 12, and provides support to micro prism film 11 and micro-structure lens array 14 (if present) above layer 16. The light emitted from the OLED emissive layer 12 has a very wide divergent light angle of about 170 degrees, so without an optical collimating structure only a relatively small portion of the emitted light would be collected by the projection optics, thereby resulting in low projection engine efficiency. A micro prism film 11, described below, collimates the emitted light, thereby improving efficiency.

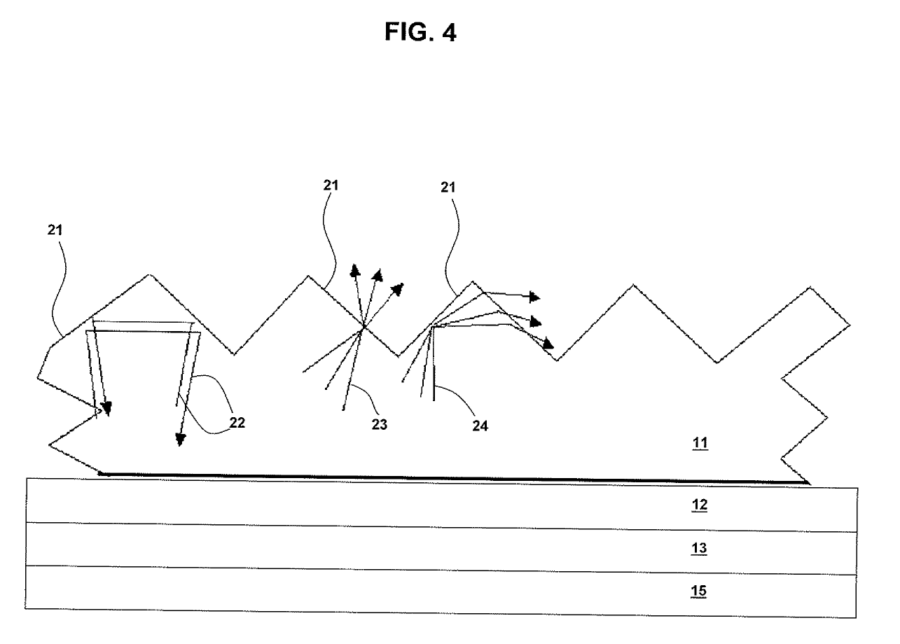

The micro prism film 11 is made up from a plurality of micro prisms 11A. The micro prism film 11 is disposed adjacent to an OLED emissive layer 12 made from a plurality of individual OLEDs 12A. FIG. 3 illustrates a micro prism 11A disposed over each OLED 12A, but a person of ordinary skill in the relevant art will recognize that the micro prisms 11A may be larger or smaller than an OLED 12A, and may have an alignment that is offset from the OLEDs 12A. Micro prism film 11 may be made from other than a plurality of micro prisms 11A, for instance a plurality of lenses. FIG. 4, discussed below, further describes how the micro prism 11A collimates the emitted light. Micro prism film 11 collimates the light to a divergent light angle of about ±20 degrees.

Optionally, above the micro prism film 11 is a micro-structure lens array 14, made from individual lenses 14A. The micro-structure lens array 14 further collimates the output light to control its angle within the cone angle of small F/# projection optic subsystem, for instance less than ±15 degrees.

Both the micro prism film 11 micro-structure lens array 14 have the same cross-sectional structure in the axis perpendicular to the plane of FIG. 3. If viewed from above, both the micro prism film 11 micro-structure lens array 14 preferably would cover the entire plane overlying the OLED emissive layer 12, i.e., forming a tessellation. Any small gaps between the individual lenses 14A or micro prisms 11A would be a source of undesirable light leakage. Preferable, an individual micro prism 11A and/or individual lens 14A substantially overlies each of at least some OLED 12A, so that the divergent light angle of an OLED 12A is best matched to the light collection angle of the individual micro prism 11A and/or individual lens 14A, but other arrangements are possible. For instance, a single micro prism 11A and/or individual lens 14A may overlie a plurality of OLED 12A; or an offset arrangement may exist between the single micro prism 11A or individual lens 14A, and the OLED 12A, such offset arrangement being usable but at reduced efficiency.

Below the OLED emissive layer 12 is a reflective layer 13 that reflects back toward the output of engine 102 any light originally emitted downward by OLED emissive layer 12, and/or light that was reflected downward by the micro prism film 11. Below the reflective layer 13 is a silicon substrate 15. The silicon substrate 15 provides physical support and electrical connections (not shown) from the OLED emissive layer 12 to a power source. The relative sizes of certain features of FIG. 3 are exaggerated for clarity.

FIG. 4 illustrates the collimation performed by the micro prism film 11. The relative sizes of certain features are exaggerated for clarity. Light emitted from the OLED emissive layer 12 within a predetermined divergent light angle will be collimated by the micro prism film 11. The limit on the divergent light angle is determined by the geometry of the individual micro prisms 11A, specifically the angle of incidence of light rays at the boundary 21 of the micro prism film 11 with the immersing medium surrounding micro prism film 11 (usually air). If a light ray encounters this boundary 21 at an angle greater than the Brewster angle, the light ray will be reflected. Persons of ordinary skill in the relevant art will know that the Brewster angle can be derived from the index of refraction of the micro prism film 11 and that of the immersing medium.

Several exemplary ray traces are shown in FIG. 4. Light rays 23 encounter boundary 21 at less than the Brewster angle, and are refracted as they pass through boundary 21. Light rays 22 are reflected twice from boundary 21 and travel back toward the OLED emissive layer 12. Light rays 24 reflect once from boundary 21, and pass through a second encounter with boundary 21. An infinite number of ray traces are possible.

Light reflected from the micro prism film 11 toward the OLED emissive layer 12 will be further reflected from reflective layer 13 underneath the OLED light emitting layer 12, back toward the micro prism film 11, whereupon the light will again be either reflected from, or refracted passing through, boundary 21 depending upon the new angle of incidence.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. An apparatus for compact and efficient projection of a display, comprising:
an emissive micro-display panel, configured to produce an emitted display on a first side of the emissive micro-display panel; and
a first collimation optic plate disposed overlying the first side of the emissive micro-display panel, configured to accept the emitted display and produce a projected display,
wherein the projected display has a divergent light angle less than a divergent light angle of the emitted display.

2. The apparatus according to claim 1, further comprising:
a semiconductor backplane supporting the emissive micro-display panel on a second side of the emissive micro-display panel;
a reflective layer disposed between the semiconductor backplane and the emissive micro-display panel, wherein the emissive micro-display panel is at least partially transmissive of a first-reflected light reflected from the first collimation optic plate, and the reflective layer is configured to reflect the first-reflected light toward the first collimation optic plate, producing a second-reflected light.

3. The apparatus according to claim 1, further comprising:
a projection optic subsystem, configured to accept the projected display as an input, and to focus an image of the projected display onto a display plane.

4. The apparatus according to claim 3, wherein the projection optic subsystem is selected from the group consisting of a pair of lenses forming an objective lens and focal lens, a single magnifying lens, and an eyepiece.

5. The apparatus according to claim 1, wherein the first collimation optic plate comprises a micro-structure lens array.

6. The apparatus according to claim 1, wherein the first collimation optic plate comprises a collimation prism film.

7. The apparatus according to claim 1, wherein the first collimation optic plate is integrated with the emissive micro-display panel.

8. The apparatus according to claim 1, wherein a cover layer is disposed between the first collimation optic plate and the emissive micro-display panel.

9. The apparatus according to claim 1, wherein a second collimation optic plate is disposed overlying the first collimation optic plate.

10. A method for compactly and efficiently projecting an emitted display, comprising:
emitting a display on a first side of a emissive micro-display panel; and
collimating the emitted display by use of a first collimation optic plate disposed overlying the first side of the emissive micro-display panel, producing a projected display,
wherein the projected display has a divergent light angle less than a divergent light angle of the emitted display.

11. The method according to claim 10, further comprising:
supporting the emissive micro-display panel on a second side of the emissive micro-display panel by use of a semiconductor backplane; and
reflecting a first-reflected light, reflected from the collimation optic plate, by use of a reflective layer disposed between the semiconductor backplane and the emissive micro-display panel, wherein the reflective layer is configured to reflect the first-reflected light toward the first collimation optic plate, to produce a second-reflected light.

12. The method according to claim 11, further comprising:
focusing the projected display onto a viewable surface.

13. The method according to claim 11, further comprising:
supporting the first collimation optic plate by use of a cover layer disposed between the first collimation optic plate and the emissive micro-display panel.

14. The method according to claim 11, further comprising:
further collimating the collimated light by use of a second collimation optic plate disposed to accept light produced by the first collimation optic plate.
